(19) United States
(12) Patent Application Publication
(10) Pub. No.: US 2023/0270272 A1
(43) Pub. Date: Aug. 31, 2023

(54) CHILLED SLAB SYSTEM

(71) Applicant: Haier US Appliance Solutions, Inc., Wilmington, DE (US)

(72) Inventors: Kyle Andrew Kozinski, Louisville, KY (US); James Lee Armstrong, Louisville, KY (US); Sabrina Marie Hannah, Louisville, KY (US)

(21) Appl. No.: 17/682,152

(22) Filed: Feb. 28, 2022

(51) Int. Cl. A47G 23/06

(52) U.S. Cl. CPC A47G 23/0683; A47G 2200/166

(57) ABSTRACT

A chillable slab system includes a temperature sensor disposed within an interior chamber of the slab, and a controller. The controller is in communication with the temperature sensor such that a temperature of the slab is measurable by the controller via the temperature sensor. Additionally, one or both of a battery and a charging coil is disposed within the interior chamber of the slab.

### FIELD OF THE INVENTION

The present subject matter relates generally to chilled slab systems.

### BACKGROUND OF THE INVENTION

A chilled surface is commonly used in the preparation and serving of chilled desserts, such as mixed ice creams, yogurts, and puddings. Using a chilled surface in the preparation of cold desserts provides an opportunity for many different flavor options. Chilled surfaces are used to keep the ice cream cold while toppings are mixed into the ice cream. The chilled surface lets users customize the dessert, which adds to the experience of making the dessert. Eventually, the chilled surface will warm up from the ambient temperatures and the chilled dessert may begin melting.

Certain types of surfaces have very high thermal masses and can retain low temperatures for long periods of time when chilled. Chilled surfaces may be metal, either in the form of a bowl or a countertop system. The countertop system is a fully self-contained system and contains both a refrigeration system and the preparation surface all-in-one. The countertop system is bulky and takes up counter space and storage space in a user's home. Other products, such as a bowl or a stone slab, are put into a freezer to chill. These products may take several hours or even days to cool down to temperature.

### BRIEF DESCRIPTION OF THE INVENTION

Aspects and advantages of the invention will be set forth in part in the following description, or may be apparent from the description, or may be learned through practice of the invention.

In one example embodiment, a chillable slab system includes a slab defining an interior chamber. The slab also includes a temperature sensor disposed within the interior chamber of the slab and a controller disposed within the interior chamber of the slab. The controller is in communication with the temperature sensor such that a temperature of the slab is measurable by the controller via the temperature sensor. Additionally, one or both of a battery and a charging coil is disposed within the interior chamber of the slab. The battery configured to supply power to the controller.

In another example embodiment, a method of chilling a slab includes chilling the slab in a freezer, wherein the slab comprises a temperature sensor disposed within the slab. Then charging a battery included in the slab while the slab is in the freezer. The battery supplies power to a controller disposed in the slab. Next, removing the slab from the freezer and monitoring the temperature sensor of the slab from an external device in network communication with the controller. The controller is configured for network communication.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a top down view of an example slab of the present disclosure.

FIG. 2 illustrates a side, plan view of the slab of FIG. 1.

FIG. 3 is a flow chart illustrating a method for chilling and using a slab according to an example embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

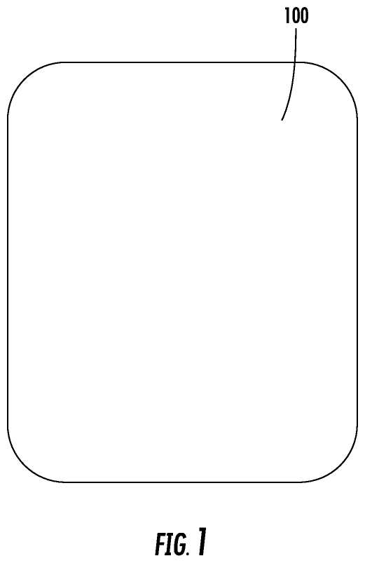

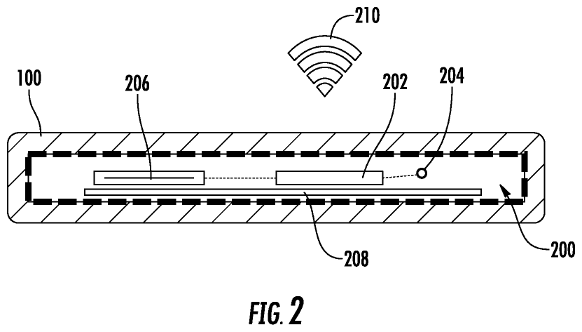

FIGS. 1 and 2 show a slab 100 according to an example embodiment. A user may use slab 100 to craft chilled deserts. Slab 100 may be chilled, e.g., within a freezer, to a desired temperature such that the surface of slab 100 does not cause the chilled dessert to melt. Slab 100 may be fabricated from stone, such as marble or granite, or may be ceramic, due to the materials having high thermal properties. As an example, slab 100 may have a heat capacity that advantageously allows preparation and/or working of chilled or frozen food items on the surface of slab 100. In certain example embodiments, slab 100 may have a thickness of between about two and a half of a centimeter (2.5 cm) and about five centimeters (5 cm). In certain example embodiments, the working surface of slab 100 may have an area of about one-hundred and fifty-six square centimeters (156 cm²). The top, working surface of slab 100 may be smooth, whereas the bottom of slab 100 may have an opening, or indentation, for internal components. The top, working surface of slab 100 may face upwardly when slab 100 is positioned on a countertop, table, or other supporting structure.

Slab 100 may define or contain an interior chamber 200. Interior chamber 200 may be an indentation on the underside, or bottom, of slab 100, or, as shown in FIG. 2, may be drilled or otherwise formed internally within slab 100. Housed within interior chamber 200 may be a controller 202, temperature sensor 204, battery 206, and coil 208. For example, coil 208 may be an induction charging coil, used to charge battery 206. Battery 206 may also be a removable style battery, e.g., such that a user may replace the battery at any time. Additionally, battery 206 may supply power to controller 202. Further, controller 202 may be in communication with temperature sensor 204, e.g., such that controller 202 receives signal(s) corresponding to the temperature of slab 100 (e.g., the temperature of the working surface of slab 100) and the temperature measurements from sensor 204 may be monitored by controller 202. In certain example embodiments, temperature sensor 204 may be installed at a depth of about half of a centimeter (0.5 cm) and about four and a half centimeters (4.5 cm) from the top surface of slab 100. Such positioning of temperature sensor 204 may advantageously assist temperature sensor 204 with measuring (e.g., indirectly) the temperature of the top surface of slab 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 202 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 202 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

Controller 202 may be in operative communication with an external device (not shown) via an external communication system 210. For example, external communication system 210 permits an external device to communicate with controller 202. As described in more detail below, these communications may be facilitated using a wired or wireless connection, such as via a network (not shown). In general, the external device may be any suitable device separate from slab 100 that is configured to provide and/or receive communications, information, data, or commands from a user. In this regard, the external device may be, for example, a personal phone, a smartphone, a tablet, a laptop or personal computer, a wearable device, a smart home system or appliance, or another mobile or remote device. Controller 202 may be configured to share information regarding the temperature of slab 100 pulled from temperature sensor 204 with the external device via external communication system 210 and the network.

In general, external communication system 210 may be any type of wired or wireless connection and using any suitable type of communication network, non-limiting examples of which are provided below. For example, the network may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 210 is described herein according to an example embodiment of the present subject matter. However, it should be appreciated that the example functions and configurations of external communication system 210 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Slab 100 may be an accessory for a refrigerator. As stated above, slab 100 may be made from a multitude of hard mineral compounds, such as marble or granite, or a material such as ceramic, and is intended to be chilled to sub-freezing temperatures. Temperature sensor 204 may communicate the average bulk temperature of slab 100 through controller 202 to a user or the associated refrigerator for use in conjunction with a special temperature controlled drawer inside the refrigerator. Using the mass and material properties of slab 100 and temperature sensor 204, the refrigerator may then either adjust the temperature of the drawer up or down to cool the stone to a specific setpoint, or monitor the temperature rise/drop to alert the user when the stone will be ready for use. Slab 100 may then be used as a cold surface for preparing foods, such as mixing ice creams, as a meat/cheese serving tray, etc. Other example embodiments may use a wired thermocouple system which requires a cord with a connector to be plugged into an accessory port within the refrigerator.

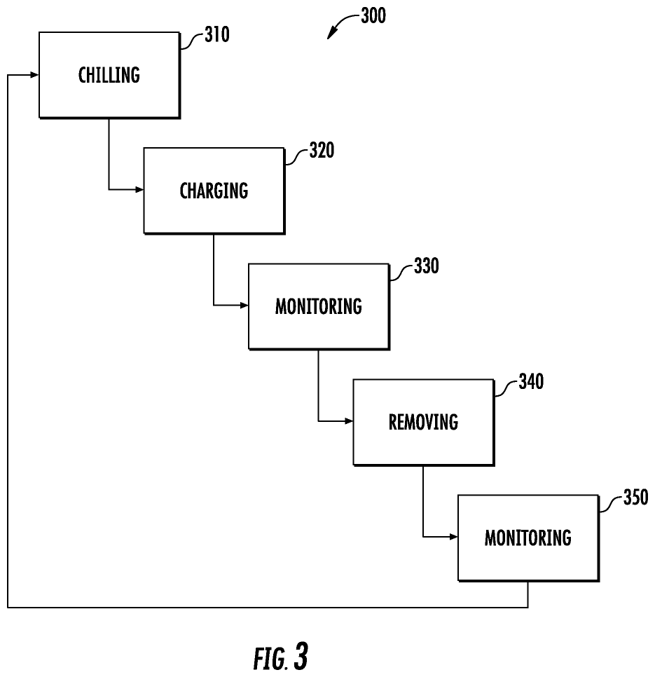

FIG. 3 provides method 300 which depicts the steps a user may take to chill and use slab 100. At 310, slab 100 is placed into a freezer or temperature-controlled drawer of a refrigerator appliance and slab 100 is chilled to a desired temperature therein. At 320, a battery within the slab 100 is charged while the slab 100 is in the freezer. Slab 100 may connect to the appliance via a cord with a connector to be plugged into an accessory port within the appliance, or slab 100 may charge via induction charging coils 208. At 330, the temperature of slab 100 is monitored. The monitoring of the slab 100 may be done by an external device, as mentioned above, or via a display on the appliance. As soon as the slab 100 reaches a desired temperature, typically about negative sixteen degrees Celsius (−16° C.), a notification or alert may be sent to the user that the slab 100 is ready for use. Thus, at 340 the slab 100 may also be removed from the freezer for use. The user may then begin using slab 100, moving to 350 where the user will begin monitoring the temperature of slab 100, making sure the slab 100 remains chilled through use, until slab 100 reaches an undesirable temperature of typically about four and a half degrees Celsius (4.5° C.).

In one example embodiment, a user may input a “ready by” time, or date, through an external device. Then controller 202 of slab 100 analyzes the current temperature, the material properties of slab 100, and the performance of their particular refrigerator appliance model to calculate the window of time required for slab 100 to be put into the freezer chamber to have slab 100 ready by that time. For example, the user may want to make ice cream at seven o'clock in the afternoon on the fourth of February, and controller 202 of slab 100 determines that, based on the temperature of the freezer chamber and slab 100, slab 100 needs to be put into the freezer chamber no later than eight o'clock in the afternoon on the third of February to have slab 100 ready at that the selected “ready by” time.

In another example embodiment, a user may not know the ideal temperature to set slab 100 to, thus preset temperatures may be included. The user may select from options, such as yogurts, parfaits, ice cream, etc., and controller 202 of slab 100 may be programmed with a respective preset temperature for each of the different items. For example, ice cream has an ideal working temperature between negative fifteen degrees Celsius (−15 C.°) to negative twelve degrees Celsius (−12 C°), whereas frozen yogurt is negative eight degrees Celsius (−8 C.°) to negative seven degrees Celsius (−7 C°). The preset options may also adjust the temperature setpoint where the user is alerted that slab 100 is getting too warm and needs to be re-frozen. As such, since frozen yogurt has a higher workable temperature, theoretically the user could use slab 100 for a longer period of time than if the user were working with ice cream.

As may be seen from the above, a slab 100 may be an accessory for a refrigerator appliance. Slab 100 may be granite, marble, or ceramic, and have a built-in temperature sensor 204. Slab 100 is intended to be chilled to sub-freezing temperatures, whereupon reaching the desired temperature measure by temperature sensor 204, controller 202 of slab 100 may communicate with an external device such as a user's smartphone, via external communication system 210 to alert the readiness of slab 100 to the user. While inside the refrigerator appliance, slab 100 may charge battery 206 through coil 208, which may be induction charging coils. Battery 206 may also be a removable style battery, e.g., such that a user may replace the battery at any time. An external device may also be used to monitor the temperature of the slab while in the refrigerator appliance or during use. Upon removing slab 100 from the refrigerator appliance, slab 100 may alert the user when the temperature of the slab 100 has exceeded the desirable working range, whereupon slab 100 may be returned to the refrigerator appliance to begin rechilling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A chillable slab system, comprising:
a slab defining an interior chamber;
a temperature sensor disposed within the interior chamber of the slab;
a controller disposed within the interior chamber of the slab, the controller in communication with the temperature sensor such that a temperature of the slab is measurable by the controller via the temperature sensor; and
one or both of a battery and a charging coil disposed within the interior chamber of the slab, the battery configured to supply power to the controller.

2. The slab of claim 1, wherein the charging coil is an induction charging coil.

3. The slab of claim 1, wherein the interior chamber is sealed within the slab.

4. The slab of claim 1, wherein a thickness of the slab is no less than about two and a half centimeters and no greater than about five centimeters, and an area of a work surface of the slab is no less than two hundred square centimeters and no greater than six hundred square centimeters.

5. The slab of claim 1, wherein when the slab comprises both the battery and the coil, the coil configured to charge the battery.

6. The slab of claim 1, wherein when the slab is one of granite, marble, and ceramic.

7. The slab of claim 1, wherein the temperature sensor is disposed within the slab at a depth no less than half a centimeter and no greater than two centimeters from a work surface of the slab.

8. The slab of claim 1, wherein the interior chamber is one of drilled within the slab and an indentation in a bottom of the slab.

9. The slab of claim 1, wherein the controller is configured for network communication to an external device.

10. The slab of claim 1, wherein the slab is movable into a refrigerator drawer.

11. A method of chilling a slab, comprising:
chilling the slab in a freezer chamber, wherein the slab comprises a temperature sensor disposed within the slab;
charging a battery disposed within the slab while the slab is in the freezer, wherein the battery is configured to supply power to a controller disposed in the slab;
monitoring the temperature sensor of the slab from an external device in network communication with the controller;
removing the slab from the freezer; and
monitoring the temperature sensor of the slab from the external device.

12. The method of claim 11, a coil configured for charging the battery is disposed in the slab, wherein the coil is an induction charging coil.

13. The method of claim 11, wherein the battery, temperature sensor, and controller are disposed within an interior chamber of the slab, wherein the interior chamber is sealed within the slab.

14. The method of claim 11, wherein a thickness of the slab is between 2.5 and 5 centimeters, and an area of the slab is 156 square centimeters.

15. The method of claim 11, wherein when the slab is one of granite, marble, and ceramic.

16. The method of claim 11, wherein the temperature sensor is disposed within the slab at a depth between 0.5 and 2 centimeters.

17. The method of claim 11, wherein an interior chamber is drilled within the slab.

18. The method of claim 11, wherein the slab is movable into a refrigerator drawer.
